(19) United States
(12) Patent Application Publication
(10) Pub. No.: US 2014/0310440 A1
(43) Pub. Date: Oct. 16, 2014

(54) MOUNTING APPARATUS FOR EXPANSION CARDS

(71) Applicants: HON HAI PRECISION INDUSTRY CO., LTD., New Taipei (TW); HONG FU JIN PRECISION INDUSTRY (WUHAN) CO., LTD., Wuhan (CN)

(72) Inventors: JIAN YUAN, Wuhan (CN); ZHI-PING WU, Wuhan (CN); TING-TING HE, Wuhan (CN); CHAO LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/079,940

(22) Filed: Nov. 14, 2013

(30) Foreign Application Priority Data
Apr. 16, 2013 (CN) 2013101305464

(51) Int. Cl. G06F 13/40

(52) U.S. Cl. CPC G06F 13/409
USPC 710/301

(57) ABSTRACT

A mounting apparatus includes a case and a securing member. The case includes a bottom plate and a rear plate connected to the bottom plate. A mounting tray is attached to the rear plate and defines a receiving slot. The securing member, includes an inserting portion and a securing portion. The inserting portion is engaged in the receiving slot, and the securing portion is secured to an expansion card. The securing member is moveable in a direction that is substantially perpendicular to the bottom plate, to disengage the inserting portion from the receiving slot.

### BACKGROUND

1. Technical Field

The present disclosure relates to mounting apparatuses, and particularly to a mounting apparatus for securing expansion cards in an electronic device.

2. Description of Related Art

Computer systems usually include multiple expansion cards, such as sound cards, video cards, graphics cards for enhancing capabilities of the computer system. Long expansion cards may be coupled to a circuit board and secured at only one end to a front wall of a computer system enclosure, which may not provide enough stability, particularly during transportation of the computer system. Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and a plurality expansion cards in accordance with an embodiment.

FIG. 2 is similar to FIG. 1, but viewed from a different aspect.

FIG. 3 is an assembled view of the mounting apparatus and the plurality expansion cards of FIG. 1

FIG. 4 is similar to FIG. 1, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

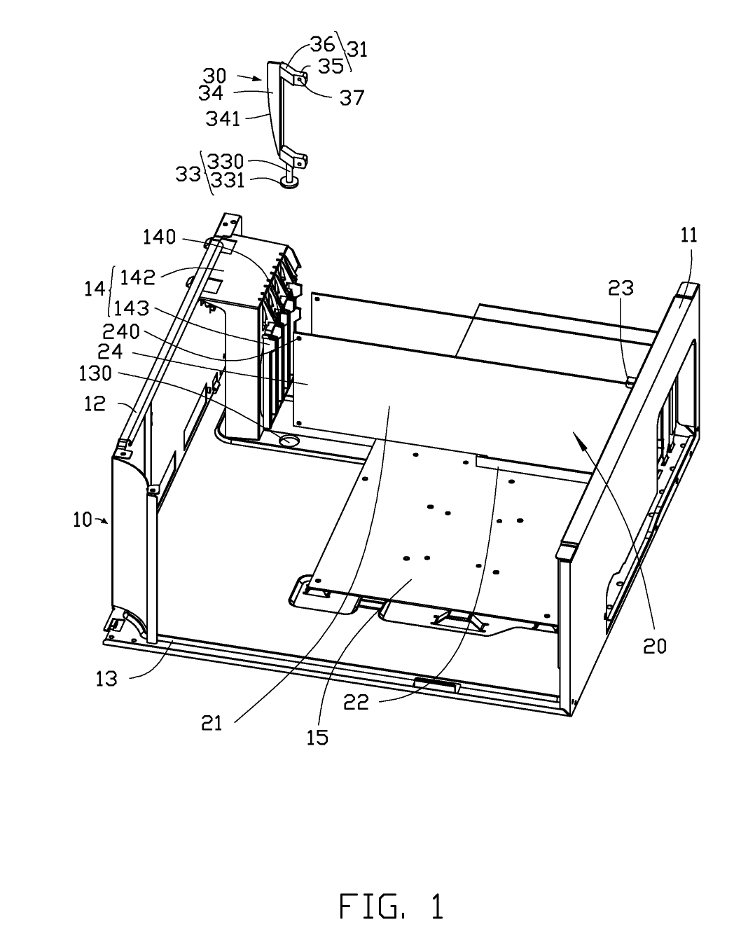

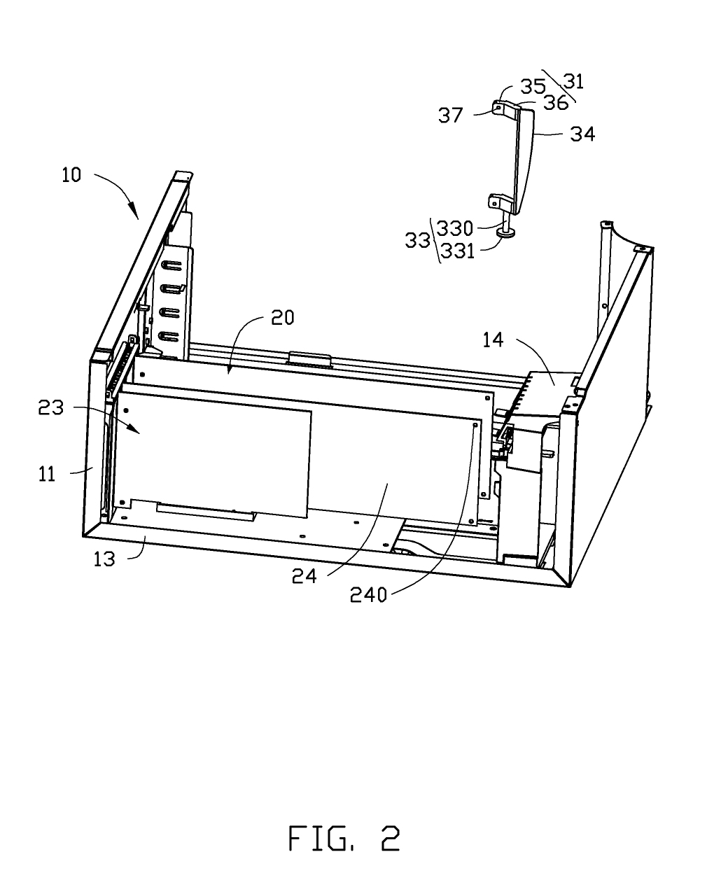

FIGS. 1-3 illustrate a mounting apparatus in accordance with an embodiment for securing a plurality of expansion cards 20. In one embodiment, the expansion cards 20 may be, for example, sound cards, video cards, graphics cards, or other peripheral component interconnection cards. Each expansion card 20 comprises a front end 23 and a rear end 24 opposite to the front end 23. The rear end 24 defines two mounting holes 240.

The mounting apparatus comprises a case 10 and a securing member 30. The case 10 comprises a bottom plate 13, a front plate 11, and a rear plate 12. In one embodiment, the front plate 11 and the rear plate 12 substantially perpendicularly extend from a front edge and a rear edge of the bottom plate 13, respectively. A circuit board 15 is located on the bottom plate 13, and a plurality of expansion slots 22 is located on the circuit board 15. The bottom plate 13 defines a plurality of receiving holes 130, and each receiving hole 130 is adjacent to the rear end 24 of the expansion card 20.

A mounting tray 14 is secured to the rear plate 12 and comprises a main body 142 and a plurality of retaining panels 143 connected to the main body 142. Each retaining panel 143 is substantially perpendicular to the bottom plate 13 and the rear plate 12. A retaining slot 140 is defined every adjacent two retaining panels 143, and an extending direction is substantially perpendicular to the bottom plate 13.

The securing member 30 comprises an inserting portion 34, two securing portions 31 extending from opposite ends of the inserting portion 34, and a positioning portion 33 extending one of the two securing portions 31. The inserting portion 34 comprises a curved surface 341 for guiding the inserting portion 34 to extend into the retaining slot 140. Each securing portion 31 comprises a securing block 35 and a connecting portion 36 connected to the securing block 35 and the inserting portion 34. In the illustrated embodiment, a sharp angle is defined between the connecting portion 36 and the inserting portion 34, and an obtuse angle is defined between the securing block 35 and the connecting portion 36. The securing block 35 defines a securing hole 37. The positioning portion 33 comprises a connecting post 330 and a positioning block 331 connected to the connecting post 330.

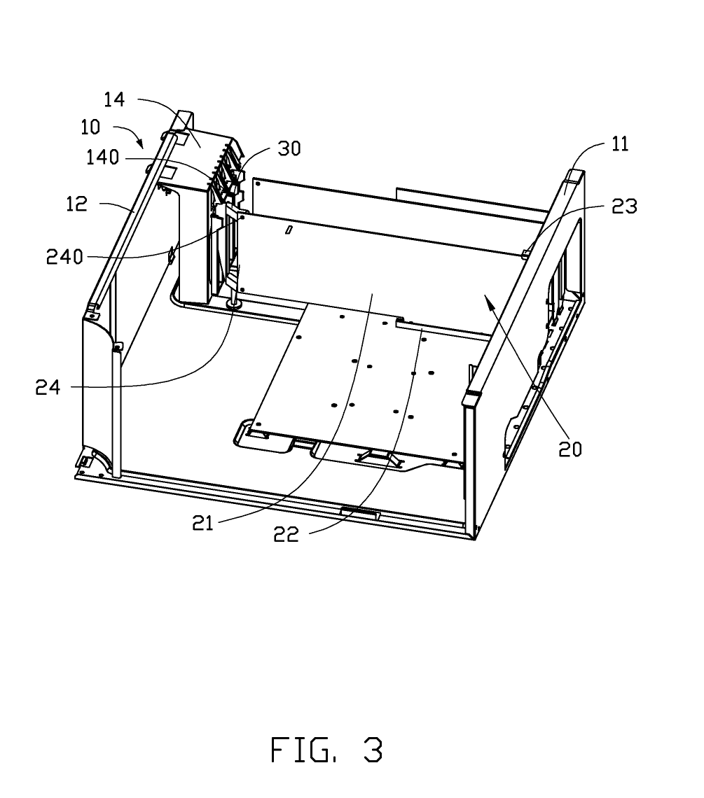

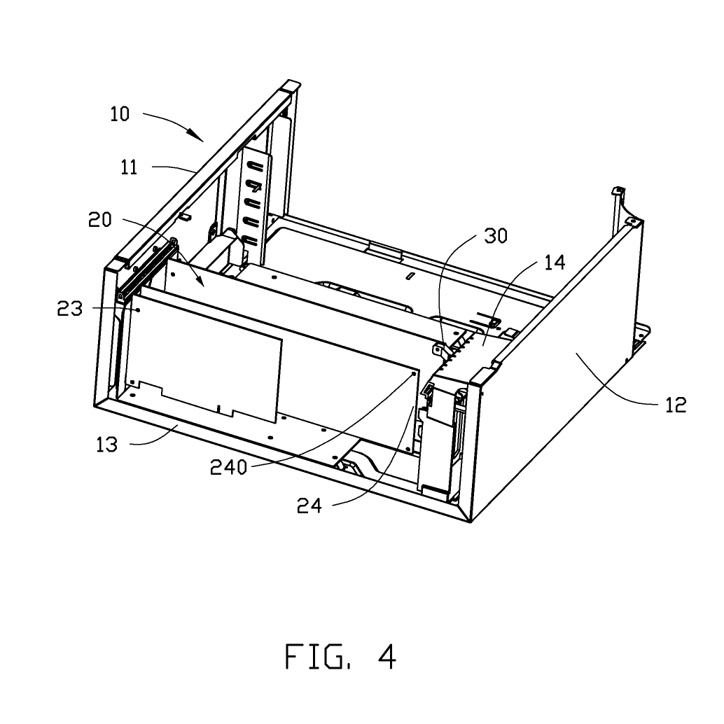

FIGS. 3-4 illustrate that in assembly, the expansion card 20 is inserted into the expansion slot 22, and the front end 23 of the expansion card 20 is secured to the front plate 11. The securing member 30 is located above the mounting tray 14 and moved in a first direction that is substantially perpendicular to the bottom plate 13, until the inserting portion 34 is aligned with the retaining slot 140. The securing member 30 is further moved in the first direction, and the inserting portion 34 is slid in the retaining slot 140. Until the positioning block 331 is received in the receiving hole 130, the securing member 30 stops moving. The securing holes 37 are aligned with the mounting holes 240. Two fixing members (not shown), such as screws, are engaged in the securing holes 35 and the mounting holes 240, to secure the securing member 30 to the expansion card 20.

In disassembly, the two fixing members are detached from the securing holes 35 and the mounting holes 240. The securing member 30 is moved in a second direction that is opposite to the first direction, and the inserting portion 34 is removed from the retaining slot 140. Thus, the rear end 24 of the expansion card 20 cannot be blocked by the securing member 30, and the front end 23 of the expansion card 20 is detached from the front plate 11. The expansion card 20 is removed from the inserting slot 22 and can be disengaged from the case 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a case comprising a bottom plate and a rear plate connected to the bottom plate;
and a mounting tray attached to the rear plate and defining a receiving slot;
a securing member, attached to the bottom plate, comprising an inserting portion and a securing portion; and the inserting portion is engaged in the receiving slot, and the securing portion is configured to be secured to an expansion card;
wherein the securing member is moveable in a direction that is substantially perpendicular to the bottom plate, to disengage the inserting portion from the receiving slot.

2. The mounting apparatus of claim 1, wherein an extending direction of the receiving slot is substantially perpendicular to the bottom plate.

3. The mounting apparatus of claim 1, wherein the inserting portion comprises a curved surface, and the curved surface is configured to guide the inserting portion into the receiving slot.

4. The mounting apparatus of claim 1, wherein the securing member comprises a positioning portion connected to the inserting portion, and the positioning portion is attached to the bottom plate.

5. The mounting apparatus of claim 4, wherein the bottom plate defines a receiving hole, the positioning portion comprises a connecting post and a positioning block connected to the connecting post, and the positioning block is engaged in the receiving hole.

6. The mounting apparatus of claim 1, wherein the securing portion comprises a securing block and a connecting portion connected to the securing block and the inserting portion, and the securing block is configured to be secured to the expansion card.

7. The mounting apparatus of claim 6, wherein a sharp angle is defined between the connecting portion and the inserting portion.

8. The mounting apparatus of claim 6, wherein an obtuse angle is defined between the securing block and the connecting portion.

9. The mounting apparatus of claim 6, wherein the securing block defines a securing hole, the securing hole is configured to be aligned with a mounting hole of the expansion card, so that the securing hole and the mounting hole are configured to receive a fixing member to secure the securing block to the expansion card.

10. A mounting apparatus comprising:
a case comprising a bottom plate and a rear plate connected to the bottom plate; a mounting tray comprising a main body attached to the rear plate and a plurality of receiving panels connected to the main body; a receiving slot is defined between every adjacent two receiving panels;
a securing member, attached to the bottom plate, comprising an inserting portion and a securing portion; the inserting portion is engaged in the receiving slot, and the securing portion is configured to be secured to an expansion card;
wherein the securing member is moveable in a direction that is substantially perpendicular to the bottom plate, to disengage the inserting portion from the receiving slot.

11. The mounting apparatus of claim 10, wherein each receiving panel is substantially perpendicular to the bottom plate and the rear plate.

12. The mounting apparatus of claim 10, wherein the inserting portion comprises a curved surface, and the curved surface is configured to guide the inserting portion into the receiving slot.

13. The mounting apparatus of claim 10, wherein the securing member comprises a positioning portion connected to the inserting portion, and the positioning portion is attached to the bottom plate.

14. The mounting apparatus of claim 13, wherein the bottom plate defines a receiving hole, the positioning portion comprises a connecting post and a positioning block connected to the connecting post, and the positioning block is engaged in the receiving hole.

15. The mounting apparatus of claim 10, wherein the securing portion comprises a securing block and a connecting portion connected to the securing block and the inserting portion, and the securing block is configured to be secured to the expansion card.

16. The mounting apparatus of claim 15, wherein a sharp angle is defined between the connecting portion and the inserting portion.

17. The mounting apparatus of claim 15, wherein an obtuse angle is defined between the securing block and the connecting portion.

18. The mounting apparatus of claim 15, wherein the securing block defines a securing hole, the securing hole is configured to be aligned with a mounting hole of the expansion card, so that the securing hole and the mounting hole are configured to receive a fixing member to secure the securing block to the expansion card.
